(19) United States
(12) Patent Application Publication
(10) Pub. No.: US 2011/0243022 A1
(43) Pub. Date: Oct. 6, 2011

(54) WIRELESS COMMUNICATION APPARATUS

(75) Inventors: Tomoya Tandai, Kawasaki-shi (JP); Kiyoshi Toshimitsu, Tokyo (JP); Masahiro Tagaki, Tokyo (JP)

(73) Assignee: KABUSHIKI KAISHA TOSHIBA

(21) Appl. No.: 13/097,624

(22) Filed: Apr. 29, 2011

Related U.S. Application Data
(63) Continuation of application No. PCT/JP2009/068722, filed on Oct. 30, 2009.

(30) Foreign Application Priority Data
Oct. 31, 2008 (JP) 2008-282408

(51) Int. Cl. H04W 88/02; H04W 24/00; H04W 56/00

(52) U.S. Cl. 370/252; 370/350; 370/310

(57) ABSTRACT

According to one embodiment, a wireless communication apparatus includes a reception unit configured to obtain a reception signal by receiving a first packet having, as a unit, a slot including at least two repetitive symbol sequences used to transmit an identical symbol by switching antenna beams having different directions, a carrier sensing unit configured to sense a carrier for each symbol period from the reception signal, a measurement unit configured to measure a slot length from the reception signal, a generation unit configured to generate a second packet having the slot as a unit, a timer which decrements a time period until transmission of the second packet for each slot length, a control unit configured to stop, if a carrier is sensed within a time period of the slot length, the timer for the time period, a transmission unit configured to transmit the second packet according to the timer.

### CROSS-REFERENCE TO RELATED APPLICATIONS

This is a Continuation Application of PCT Application No. PCT/JP2009/068722, filed Oct. 30, 2009, which was published under PCT Article 21(2) in Japanese.

This application is based upon and claims the benefit of priority from Japanese Patent Application No. 2008-282408, filed Oct. 31, 2008; the entire contents of which are incorporated herein by reference.

### FIELD

Embodiments described herein relate generally to a wireless communication apparatus which allows a plurality of wireless stations to communicate with each other like a wireless LAN (Local Area Network).

### BACKGROUND

WirelessHD is a technique which allows fast wireless communications of 4 Gbits/sec at maximum using millimeter waves (60-GHz band) (see, for example, “WirelessHD Specification Version 1.0 Overview”). With this technique, non-compressed Hi-Vision video data (1920×1080 pixels) can be transmitted to about 10 m. This technique uses repetition coding that repetitively transmits an identical symbol continuously in different directions since it uses millimeter waves having strong rectilinear propagation characteristics.

However, when a terminal makes a media access based on CSMA/CA (Carrier Sense Multiple Access with Collision Avoidance) in the repetition coding, a carrier sensing timing changes depending on the position of the terminal. For this reason, even for an identical symbol, a terminal having a late sensing timing has a long idle period and increases a chance of packet transmission, but a terminal having an early sensing timing has a short idle period of carriers and decreases a chance of packet transmission, thus posing a problem about fairness of media accesses.

### BRIEF DESCRIPTION OF THE DRAWINGS

FIG. 1 is a view showing an example of the network configuration configured by wireless communication apparatuses according to an embodiment.

FIG. 2 is a view showing an example of the packet configuration transmitted by a wireless communication apparatus according to the first embodiment.

FIG. 3 is a view showing an example of the relationship between the packet configuration shown in FIG. 2 and slots.

FIG. 4 is a block diagram showing an example of the arrangement of the wireless communication apparatus according to the first embodiment.

FIG. 5 is a flowchart showing an example of the process from carrier sensing processing until packet transmission processing in the wireless communication apparatus shown in FIG. 4.

FIG. 6 is a block diagram showing an example of the arrangement in which a reception function is added to the wireless communication apparatus shown in FIG. 4.

FIG. 7 is a flowchart showing an example of slot synchronization processing in the wireless communication apparatus shown in FIG. 6.

FIG. 8A is a view showing an example of the allocations of wireless communication apparatuses and a repetitive symbol sequence transmitted by the wireless communication apparatus.

FIG. 8B is a view showing an example of the allocations of wireless communication apparatuses and a repetitive symbol sequence transmitted by the wireless communication apparatus.

FIG. 8C is a view showing an example of the allocations of wireless communication apparatuses and a repetitive symbol sequence transmitted by the wireless communication apparatus.

FIG. 9 is a view showing an example of the operation sequences of four wireless communication apparatuses shown in FIGS. 8A, 8B, and 8C when one repetitive symbol sequence forms one slot.

FIG. 10 is a view showing an example of the operation sequences of four wireless communication apparatuses shown in FIGS. 8A, 8B, and 8C when two repetitive symbol sequences form one slot.

FIG. 11 is a view showing an example of the packet configuration transmitted by a wireless communication apparatus according to the second embodiment.

FIG. 12 is a view showing an example of the relationship between the packet configuration shown in FIG. 11 and slots.

FIG. 13 is a view showing an example of the format of packet detection pilot symbols.

FIG. 14 is a view showing another example of the format of the packet detection pilot symbols.

FIG. 15 is a view showing still another example of the format of the packet detection pilot symbols.

FIG. 16 is a block diagram showing an example of the arrangement of the wireless communication apparatus according to the second embodiment.

FIG. 17 is a flowchart showing an example of transmission packet generation processing in the wireless communication apparatus shown in FIG. 16.

FIG. 18 is a flowchart showing an example of transmission/reception processing in the wireless communication apparatus shown in FIG. 16.

FIG. 19A is a view showing an example of the allocations of wireless communication apparatuses and a repetitive symbol sequence transmitted by the wireless communication apparatus.

FIG. 19B is a view showing an example of the allocations of wireless communication apparatuses and a repetitive symbol sequence transmitted by the wireless communication apparatus.

FIG. 20 is a view showing an example of the operation sequences of six wireless communication apparatuses shown in FIGS. 19A and 19B when a packet detection symbol sequence is inserted, and one repetitive symbol sequence forms one slot.

FIG. 21 is a block diagram showing an example of the arrangement of a wireless communication apparatus according to the fourth embodiment.

FIG. 22 is a flowchart showing an example of carrier sensing processing executed by the wireless communication apparatus shown in FIG. 21.

FIG. 23 is a view showing an example of transmission signals and reception weights of the wireless communication apparatus shown in FIG. 21.

### DETAILED DESCRIPTION

In general, according to one embodiment, a wireless communication apparatus includes a reception unit, a carrier sensing unit, a measurement unit, a generation unit, a transmission timer unit, a control unit, and a transmission unit. The reception unit is configured to obtain a reception signal by receiving a first packet having, as a unit, a slot including at least two repetitive symbol sequences used to transmit an identical symbol by switching a plurality of antenna beams having different directions. The carrier sensing unit is configured to sense a carrier for each symbol period from the reception signal. The measurement unit is configured to measure a slot length from the reception signal. The generation unit is configured to generate a second packet having the slot as a unit. The transmission timer unit is configured to decrement a time period until transmission of the second packet for each slot length. The control unit is configured to stop, when the carrier is sensed within a time period of the slot length, the transmission timer unit for the time period of the slot length. The transmission unit is configured to transmit the second packet according to the transmission timer unit.

Hereinafter, embodiments will now be described in detail with reference to the accompanying drawing.

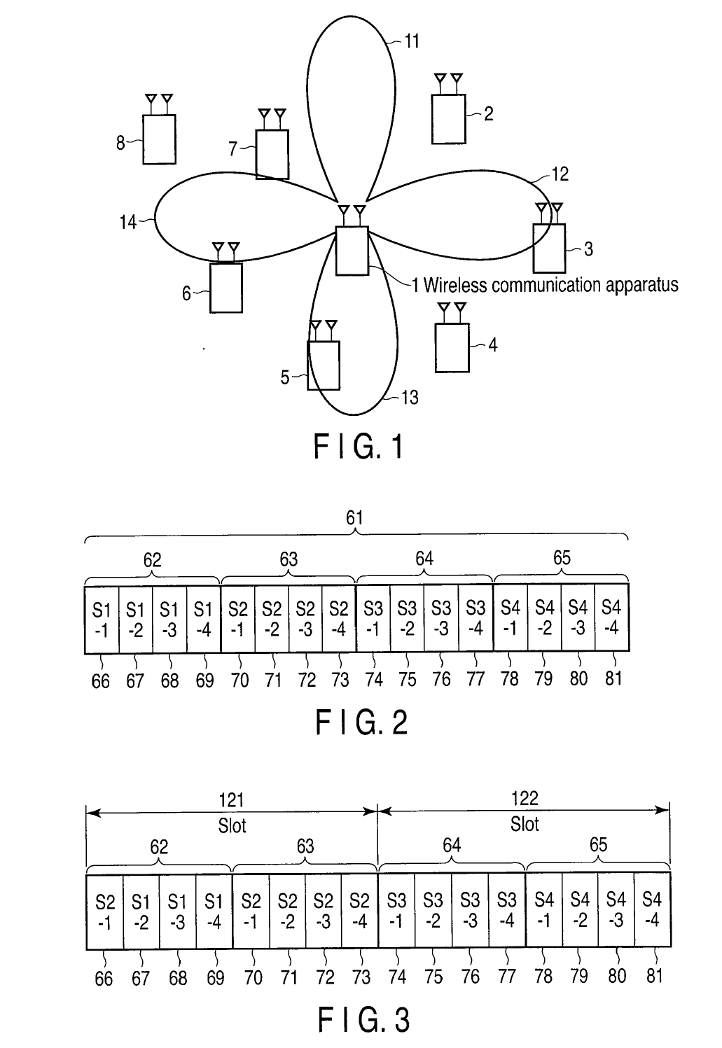

FIG. 1 shows an example of the network configuration configured by wireless communication apparatuses 1 to 8 according to the embodiment. In FIG. 1, the wireless communication apparatuses 1 to 8 make communications by sharing one frequency channel, and each wireless communication apparatus repetitively transmits an identical symbol a predetermined number of times to transmit respective symbols in different directions. For example, the wireless communication apparatus 1 communicates a packet including fields used to repetitively transmit an identical symbol by four times and to transmit the respective symbols in four different directions (11, 12, 13, and 14). The wireless communication apparatuses 1 to 8 make communications using a CSMA/CA method popularly applied to a wireless LAN. In the CSMA/CA method, in order to avoid packet collision, a terminal which wants to start a communication senses a carrier (radio waves) before the start, and transmits a packet after it confirms that the carrier is not used. Note that the wireless communication apparatuses 1 to 8 have the same arrangement, and embodiments to be described hereinafter will explain the wireless communication apparatus 1.

### FIRST EMBODIMENT

FIG. 2 is a view showing an example of the packet configuration transmitted by the wireless communication apparatus 1 shown in FIG. 1. A packet 61 transmitted by the wireless communication apparatus is configured by a set of four repetitive symbol sequences (S1, S2, S3, and S4), and has a configuration in which respective symbols are repeated four times. For example, as for symbol S1, four symbols S1-1 (66), S1-2 (67), S1-3 (68), and S1-4 (69) are repeated to configure a single repetitive symbol sequence 62. Likewise, as for symbol S2, four symbols S2-1 (70), S2-2 (71), S2-3 (72), and S2-4 (73) are repeated to configure a single repetitive symbol sequence 63. As for symbol S3, four symbols S3-1 (74), S3-2 (75), S3-3 (76), and S3-4 (77) are repeated to configure a single repetitive symbol sequence 64. As for symbol S4, four symbols S4-1 (78), S4-2 (79), S4-3 (80), and S4-4 (81) are repeated to configure a single repetitive symbol sequence 65. Furthermore, respective symbols are transmitted in different directions for each symbol. For example, the symbol S1-1 (66) is transmitted in the direction 11 shown in FIG. 1. The symbol S1-2 (67) is transmitted in the direction 12 shown in FIG. 1. The symbol S1-3 (68) is transmitted in the direction 13 shown in FIG. 1. The symbol S1-4 (69) is transmitted in the direction 14 shown in FIG. 1.

FIG. 3 is a view showing an example of the relationship between the packet configuration shown in FIG. 2 and slots. A slot used by the wireless communication apparatus 1 to sense a carrier included in a reception packet (first packet) includes at least two repetitive symbol sequences. In the example shown in FIG. 3, a slot 121 includes the repetitive symbol sequences 62 and 63, and a slot 122 includes the repetitive symbol sequences 64 and 65.

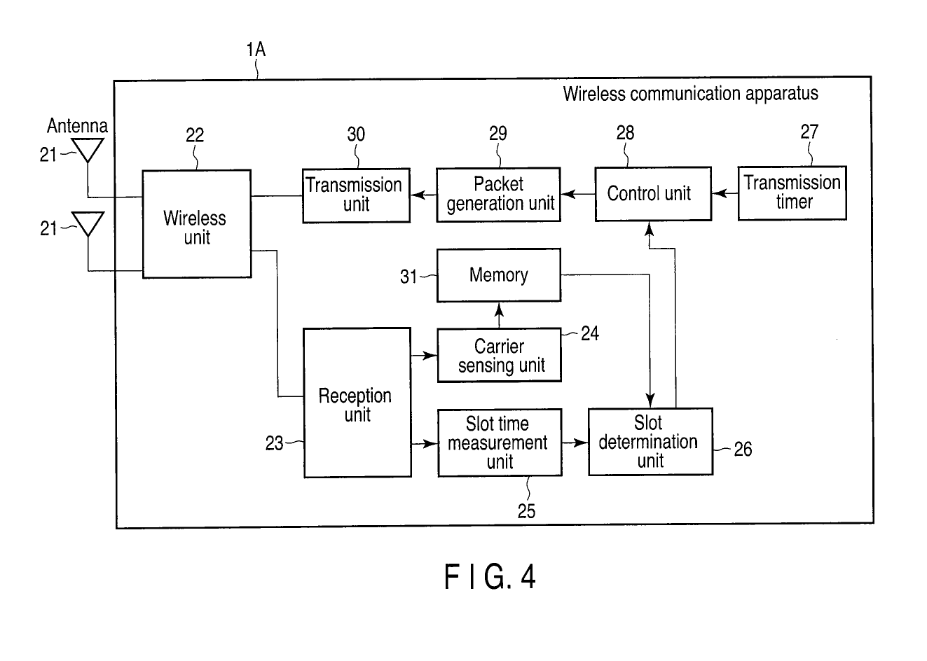

FIG. 4 is a block diagram showing an example of the arrangement of the wireless communication apparatus 1 according to the first embodiment. A wireless communication apparatus 1A includes antennas 21, a wireless unit 22, a reception unit 23, a carrier sensing unit 24, a slot time measurement unit 25, a slot determination unit 26, a transmission timer 27, a control unit 28, a packet generation unit 29, a transmission unit 30, and a memory 31. The transmission timer 27 is a back-off counter required to execute back-off control, and counts down a time period (back-off time period) until transmission of a transmission packet (second packet) for each slot length.

Each antenna 21 is configured by an adaptive antenna, and forms antenna beams in a plurality of different directions. The slot time measurement unit 25 measures a slot length (time period) which is determined in advance to include at least two repetitive symbol sequences, as described above. The carrier sensing unit 24 senses a carrier for each symbol period from a signal received by the reception unit 23, and stores the sensing result in the memory 31. The slot determination unit 26 determines based on the carrier sensing results stored in the memory 31 during the time period of the slot length whether a slot of interest is busy (a carrier is sensed) or idle (a carrier is not sensed). The control unit 28 controls the transmission timer 27 based on the slot determination result of the slot determination unit 26 to start or stop a count-down operation for each slot length. When the transmission timer 27 reaches transmission timing, a transmission packet generated by the packet generation unit 29 is transmitted from the antenna via the transmission unit 30 and wireless unit 22.

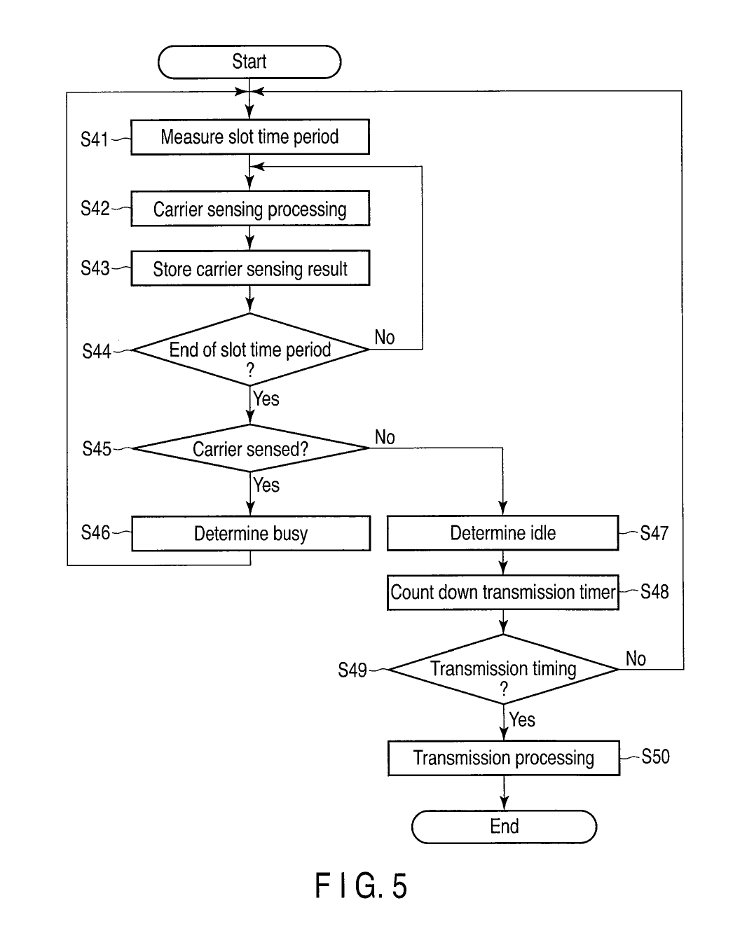

The operation of the wireless communication apparatus 1A with the aforementioned arrangement will be described below. FIG. 5 is a flowchart showing an example of the process from carrier sensing processing until packet transmission processing executed by the wireless communication apparatus 1A. The slot time measurement unit 25 begins to measure a slot time period (step S41). The carrier sensing unit 24 executes carrier sensing processing for each symbol period (step S42), and stores the carrier sensing result in the memory 31 (step S43). The slot time measurement unit 25 determines whether or not the slot time period ends (step S44). If the slot time does not end in step S44, the carrier sensing unit 24 returns the process to step S42, and repeats the processing. If the slot time period ends, the slot determination unit 26 determines based on the carrier sensing results stored in the memory 31 whether or not a carrier is sensed within the time period of the slot length (step S45). If a carrier is sensed in step S45, the slot determination unit 26 determines that the slot of interest is busy (step S46), and the process returns to step S41 to repeat the aforementioned processes.

On the other hand, if a carrier is not sensed in step S45, the slot determination unit 26 determines that the slot of interest is idle (step S47), and the transmission timer 27 performs a count-down operation for each slot length (step S48). The control unit 28 determines with reference to the transmission timer 27 whether or not a transmission timing is reached (step S49). If a transmission timing is not reached yet, the process returns to step S41 to repetitively execute the carrier sensing processing. If it is determined in step S49 that a transmission timing is reached, the control unit 28 controls the packet generation unit 29 to generate a transmission packet, and controls to transmit the generated transmission packet via the transmission unit 30, wireless unit 22, and antenna 21 (step S50).

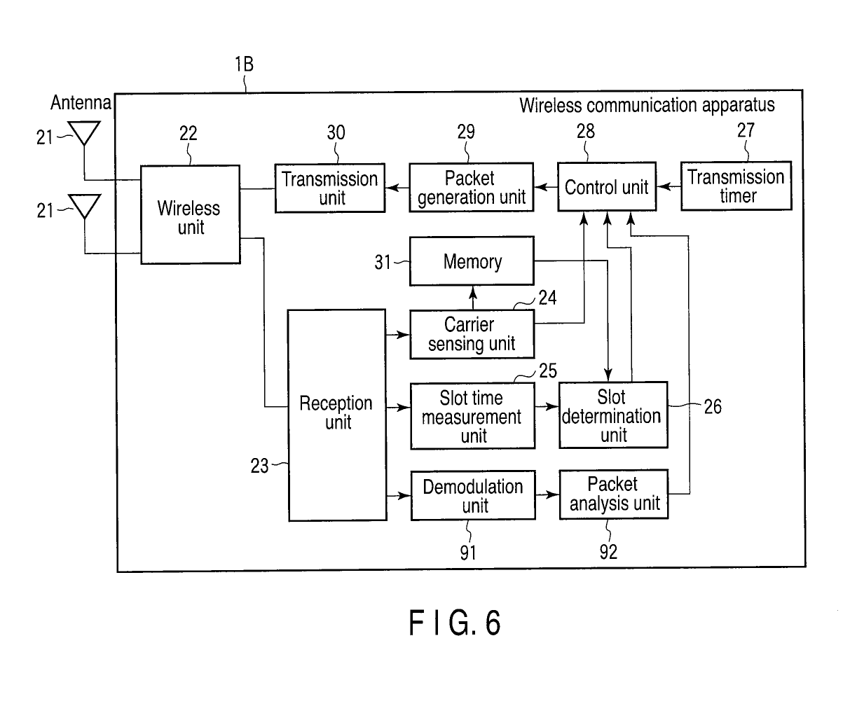

FIG. 6 is a block diagram showing an example of the arrangement in which a reception processing function is added to the wireless communication apparatus 1A, and a demodulation unit 91 and a packet analysis unit 92 are added to the block diagram shown in FIG. 4. Note that the same reference numerals denote the same parts as in FIG. 4, and a detailed description thereof will not be repeated.

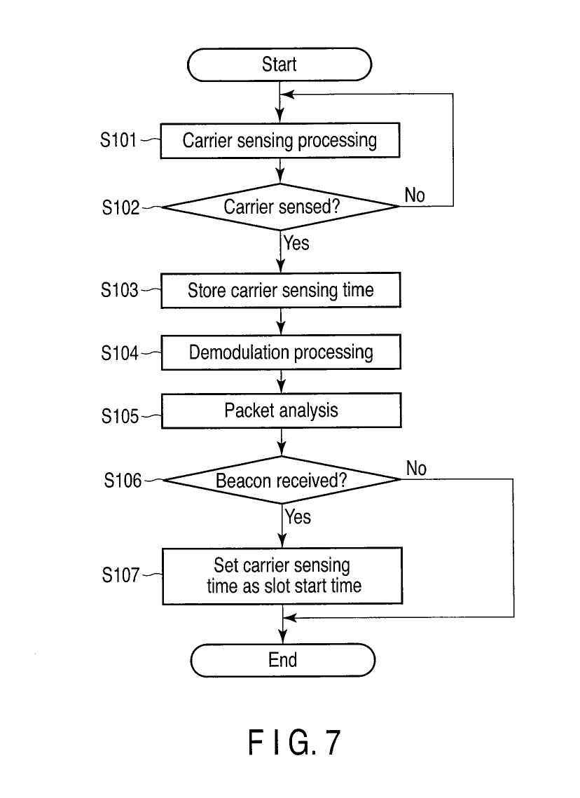

FIG. 7 is a flowchart showing an example of slot synchronization processing in a wireless communication apparatus 1B shown in FIG. 6. The carrier sensing unit 24 executes carrier sensing processing for each symbol period (step S101), and determines whether or not a carrier is sensed (step S102). If a carrier is not sensed, the carrier sensing unit 24 repeats the processing in step S101. If a carrier is sensed, the control unit 28 stores a carrier sensing time in the memory 31 (step S103). A signal input via the antenna 21, wireless unit 22, and reception unit 23 undergoes demodulation processing in the demodulation unit 91 (step S104), and the demodulated signal is input to the packet analysis unit 92 to analyze fields of a reception packet (step S105). As a result of packet analysis in step S105, the control unit 28 determines whether or not the received signal is a beacon (control information) (step S106). If the received signal is not a beacon, the processing ends; otherwise, the control unit 28 sets the carrier sensing time as a slot start time (step S107).

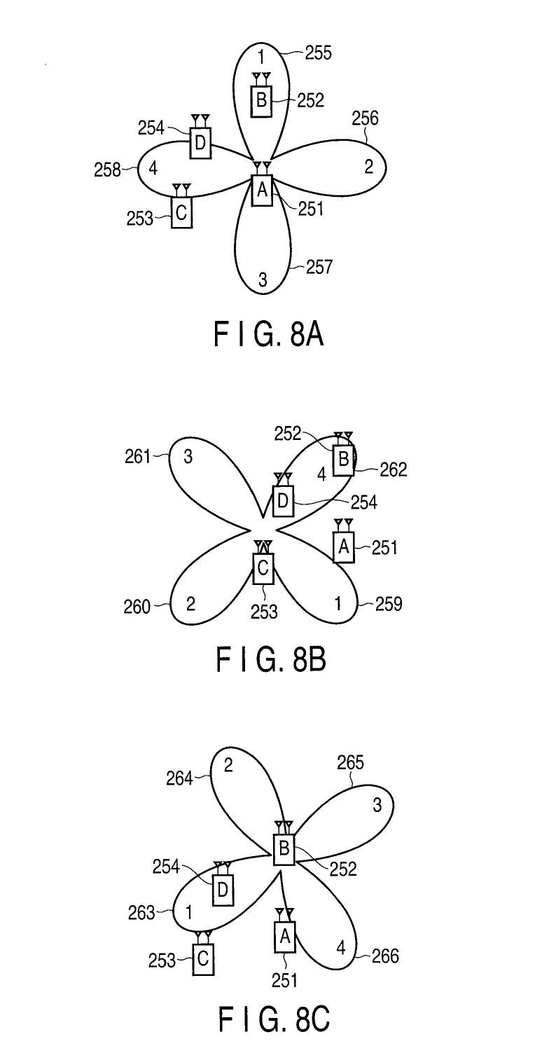

FIGS. 8A, 8B, and 8C are views showing examples of the allocations of wireless communication apparatuses and repetitive symbol sequences transmitted by the wireless communication apparatuses. In FIG. 8A, four wireless communication apparatuses, that is, a wireless communication apparatus A (251), wireless communication apparatus B (252), wireless communication apparatus C (253), and wireless communication apparatus D (254) are allocated. The wireless communication apparatus A transmits a first symbol 255, second symbol 256, third symbol 257, and fourth symbol 258. Likewise, in FIG. 8B, the four wireless communication apparatuses, that is, the wireless communication apparatus A (251), wireless communication apparatus B (252), wireless communication apparatus C (253), and wireless communication apparatus D (254) are allocated, and the wireless communication apparatus C transmits a first symbol 259, second symbol 260, third symbol 261, and fourth symbol 262. Also, in FIG. 8C, the four wireless communication apparatuses, that is, the wireless communication apparatus A (251), wireless communication apparatus B (252), wireless communication apparatus C (253), and wireless communication apparatus D (254) are allocated, and the wireless communication apparatus B transmits a first symbol 263, second symbol 264, third symbol 265, and fourth symbol 266.

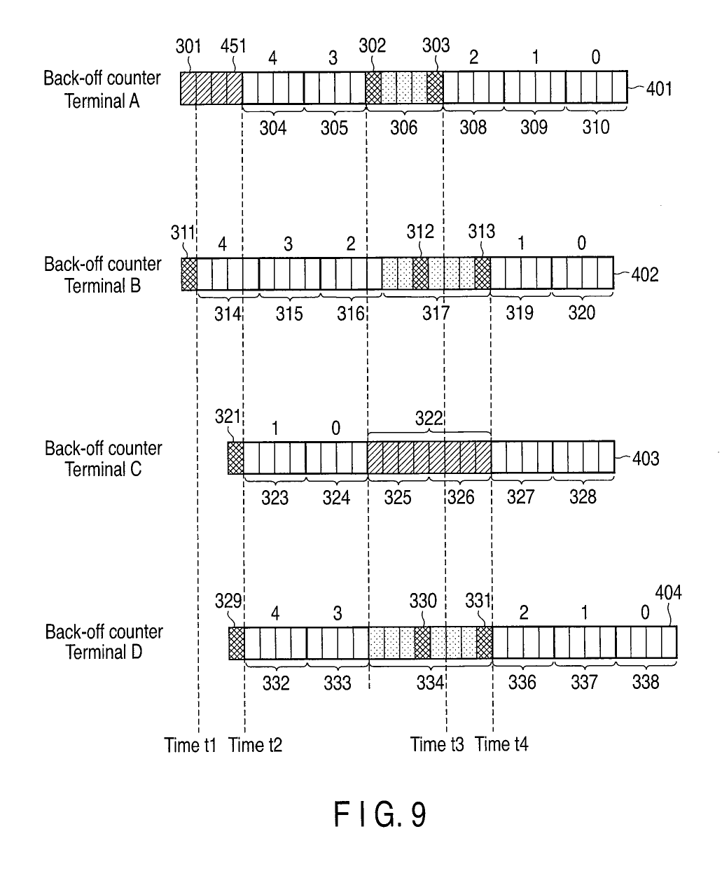

FIG. 9 is a view showing an example of the operation sequences of the four wireless communication apparatuses shown in FIGS. 8A, 8B, and 8C when one repetitive symbol sequence forms one slot. FIG. 9 shows a sequence 401 of the wireless communication apparatus A, a sequence 402 of the wireless communication apparatus B, a sequence 403 of the wireless communication apparatus C, and a sequence 404 of the wireless communication apparatus D. Assume that the wireless communication apparatus A transmits a last repetitive symbol sequence in a transmission packet at a timing shown in FIG. 8A, the wireless communication apparatus B detects a first symbol 301 transmitted by the wireless communication apparatus A (311), and the wireless communication apparatuses C and D detect a fourth symbol 451 transmitted by the wireless communication apparatus A (321, 329). The wireless communication apparatus B begins to measure a slot time period at a timing of time t1, and the wireless communication apparatuses A, C, and D begin to measure a slot time period at a timing of time t2. Now assume that transmission back-off counters in the first slot after the respective wireless communication apparatuses begin to measure the slot time period reach “4” in the wireless communication apparatuses A, B, and D, and “2” in the wireless communication apparatus C. In this state, since the respective wireless communication apparatuses do not sense a carrier, they decrement the transmission back-off counters for each slot, and the wireless communication apparatus C in which the transmission back-off counter reaches “0” first transmits a packet at a timing shown in FIG. 8B (322). The wireless communication apparatus A detects symbols 302 and 303 of the packet transmitted by the wireless communication apparatus C, the wireless communication apparatus B detects symbols 312 and 313 of the packet transmitted by the wireless communication apparatus C, and the wireless communication apparatus D detects symbols 330 and 331 of the packet transmitted by the wireless communication apparatus C. Therefore, the wireless communication apparatus A determines that a period 306 is busy, and waits without decrementing the transmission back-off counter. On the other hand, the wireless communication apparatus B determines that a period 317 is busy, and waits without decrementing the transmission back-off counter. Also, the wireless communication apparatus D determines that a period 334 is busy, and waits without decrementing the transmission back-off counter. After completion of packet transmission by the wireless communication apparatus C, the wireless communication apparatus A begins to measure a slot time period at a timing of time t3, and the wireless communication apparatuses B, C, and D begin to measure a slot time period at a timing of time t4. After completion of transmission by the wireless communication apparatus A, the values of the transmission back-off counters of the wireless communication apparatuses A, B, and D are “4”, but those of the transmission back-off counters after completion of transmission of the wireless communication apparatus C are varied like “2” in the wireless communication apparatus A, “1” in the wireless communication apparatus B, and “2” in the wireless communication apparatus D. Hence, transmission chances are unfair.

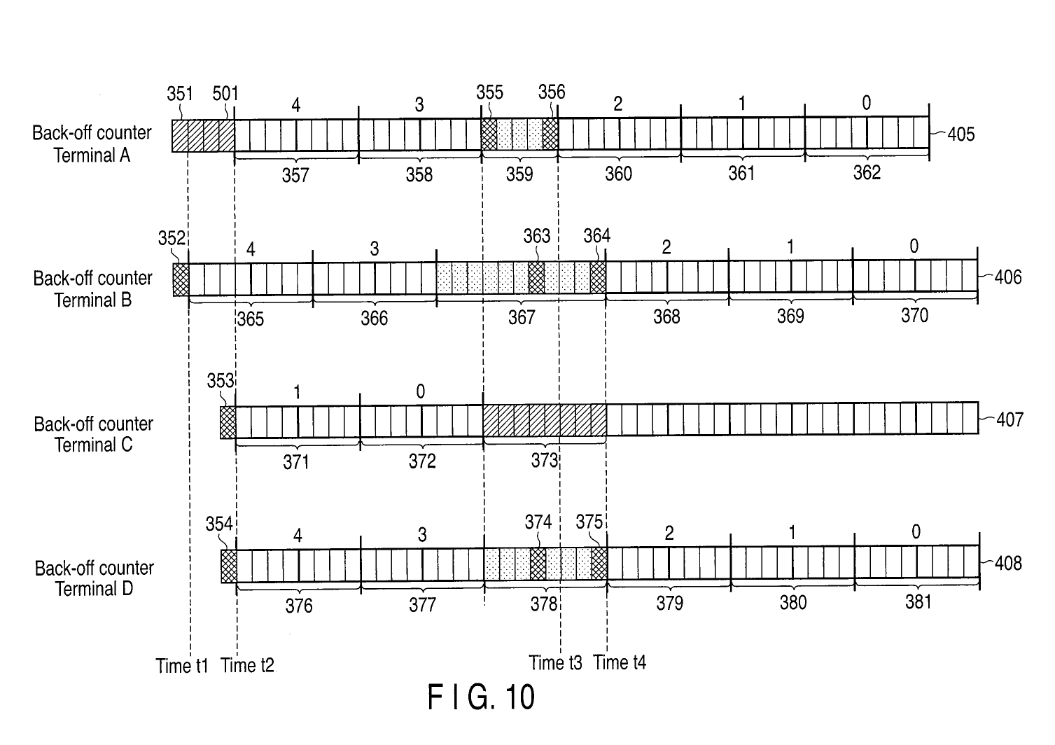

FIG. 10 is a view showing an example of the operation sequences of the four wireless communication apparatuses shown in FIGS. 8A, 8B, and 8C when two repetitive symbol sequences form one slot. FIG. 10 shows a sequence 405 of the wireless communication apparatus A, a sequence 406 of the wireless communication apparatus B, a sequence 407 of the wireless communication apparatus C, and a sequence 408 of the wireless communication apparatus D. Assume that the wireless communication apparatus A transmits a last repetitive symbol sequence in a transmission packet at a timing shown in FIG. 8A, the wireless communication apparatus B detects a first symbol 351 transmitted by the wireless communication apparatus A (352), and the wireless communication apparatuses C and D detect a fourth symbol 501 transmitted by the wireless communication apparatus A (353, 354). The wireless communication apparatus B begins to measure a slot time period at a timing of time t1, and the wireless communication apparatuses A, C, and D begin to measure a slot time period at a timing of time t2. Now assume that transmission back-off counters in the first slot after the respective wireless communication apparatuses begin to measure the slot time period reach “4” in the wireless communication apparatuses A, B, and D, and “2” in the wireless communication apparatus C. In this state, since the respective wireless communication apparatuses do not sense a carrier, they decrement the transmission back-off counters for each slot, and the wireless communication apparatus C in which the transmission back-off counter reaches “0” first transmits a packet at a timing shown in FIG. 8B (373). The wireless communication apparatus A detects symbols 355 and 356 of the packet transmitted by the wireless communication apparatus C, the wireless communication apparatus B detects symbols 363 and 364 of the packet transmitted by the wireless communication apparatus C, and the wireless communication apparatus D detects symbols 374 and 375 of the packet transmitted by the wireless communication apparatus C. Therefore, the wireless communication apparatus A determines that a period 359 is busy, and waits without decrementing the transmission back-off counter. On the other hand, the wireless communication apparatus B determines that a period 367 is busy, and waits without decrementing the transmission back-off counter. Also, the wireless communication apparatus D determines that a period 378 is busy, and waits without decrementing the transmission back-off counter. After completion of packet transmission by the wireless communication apparatus C, the wireless communication apparatus A begins to measure a slot time period at a timing of time t3, and the wireless communication apparatuses B, C, and D begin to measure a slot time period at a timing of time t4. After completion of transmission by the wireless communication apparatus A, the values of the transmission back-off counters of the wireless communication apparatuses A, B, and D are “4”, while those of the transmission back-off counters after completion of transmission of the wireless communication apparatus C are “2” in all of the wireless communication apparatuses A, B, and D. Hence, all the transmission back-off counter values are the same, and transmission chances are fair.

Therefore, since a unit including at least two or more repetitive symbol sequences is defined as one slot, as described in the first embodiment, even when repetition coding is used, fairness of transmission chances of respective terminals in CSMA/CA accesses can be maintained.

### SECOND EMBODIMENT

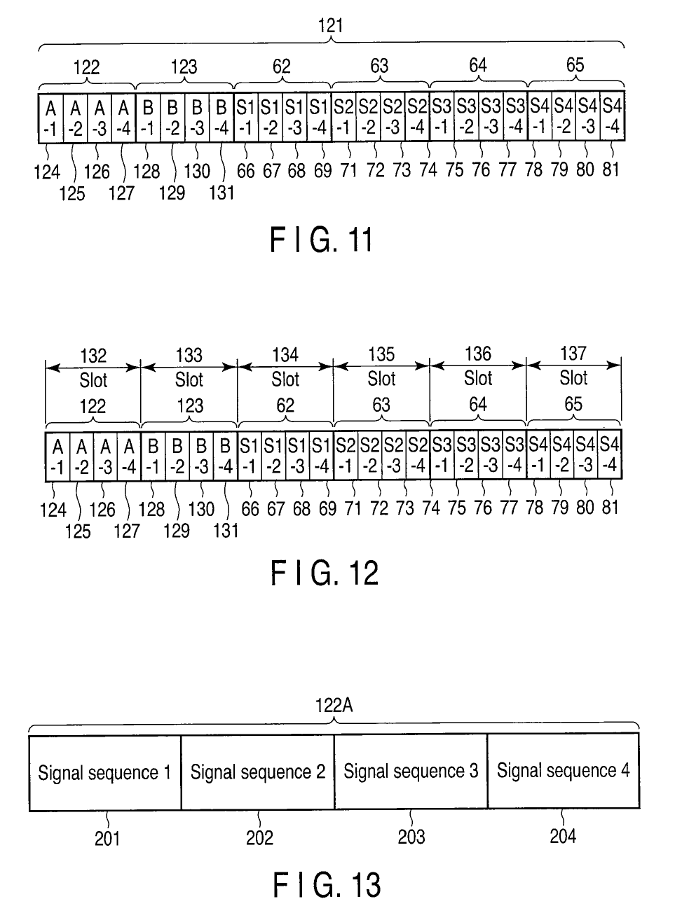

FIG. 11 is a view showing an example of the packet configuration transmitted by a wireless communication apparatus 1 shown in FIG. 1 in the second embodiment, and modifies the packet configuration shown in FIG. 2. In a packet 121 transmitted by the wireless communication apparatus 1, two packet detection symbol sequences (122 and 123) are appended to the head of the packet 61 shown in FIG. 2. The packet detection symbol sequence 122 is configured by four packet detection pilot symbols A-1 (124), A-2 (125), A-3 (126), and A-4 (127), and the packet detection symbol sequence 123 is configured by four packet detection pilot symbols B-1 (128), B-2 (129), B-3 (130), and B-4 (131).

A symbol length of each packet detection pilot symbol is equal to that of each symbol which configures a repetitive symbol sequence, and the number of packet detection pilot symbols which configure the packet detection symbol sequence is equal to that of symbols which configure the repetitive symbol sequence. Also, assume that each packet detection pilot symbol is associated with information indicating what number of a symbol in the packet detection symbol sequence that symbol is.

FIG. 12 is a view showing an example of the relationship between the packet configuration shown in FIG. 11 and slots. A slot used by the wireless communication apparatus 1 to sense a carrier includes at least one packet detection symbol sequence or repetitive symbol sequence. In the example shown in FIG. 12, a slot 132 includes a packet detection symbol sequence 122, a slot 133 includes a packet detection symbol sequence 123, a slot 134 includes a repetitive symbol sequence 62, a slot 135 includes a repetitive symbol sequence 63, a slot 136 includes a repetitive symbol sequence 64, and a slot 137 includes a repetitive symbol sequence 65.

FIGS. 13, 14, and 15 show examples of the formats of packet detection pilot symbols which configure a packet detection symbol sequence. A packet detection symbol sequence 122A shown in FIG. 13 is configured by four packet detection pilot symbols 201, 202, 203, and 204. A signal sequence 1 is assigned to the packet detection pilot symbol 201, a signal sequence 2 is assigned to the packet detection pilot symbol 202, a signal sequence 3 is assigned to the packet detection pilot symbol 203, and a signal sequence 4 is assigned to the packet detection pilot symbol 204. Also, it is determined in advance that the signal sequence 1 is a sequence transmitted first in a packet detection slot, the signal sequence 2 is a sequence transmitted second in the packet detection slot, the signal sequence 3 is a sequence transmitted third in the packet detection slot, and the signal sequence 4 is a sequence transmitted fourth in the packet detection slot. The order of these signal sequences is informed using, for example, a beacon.

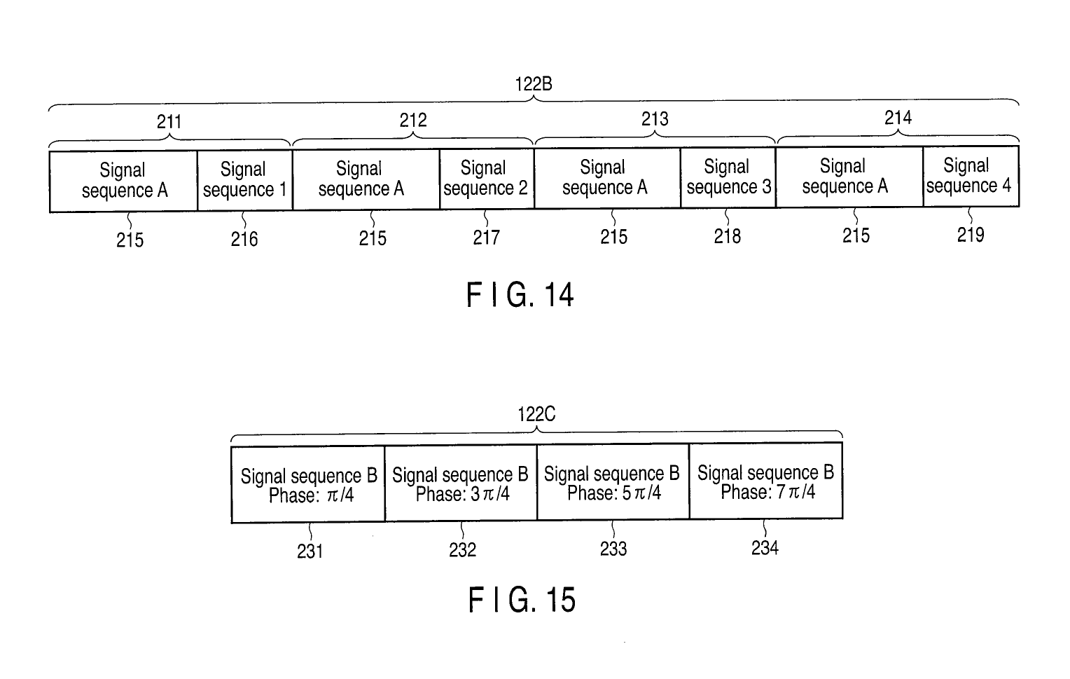

FIG. 14 shows another example of the format of packet detection pilot symbols which configure a packet detection symbol sequence. A packet detection symbol sequence 122B shown in FIG. 14 is configured by four packet detection pilot symbols 211, 212, 213, and 214. The packet detection pilot symbol 211 is configured by a signal sequence A (215) and signal sequence 1 (216). The packet detection pilot symbol 212 is configured by the signal sequence A (215) and a signal sequence 2 (217). The packet detection pilot symbol 213 is configured by the signal sequence A (215) and a signal sequence 3 (218). The packet detection pilot symbol 214 is configured by the signal sequence A (215) and a signal sequence 4 (219). Also, it is determined in advance that the signal sequence 1 is a sequence transmitted first in a packet detection slot, the signal sequence 2 is a sequence transmitted second in the packet detection slot, the signal sequence 3 is a sequence transmitted third in the packet detection slot, and the signal sequence 4 is a sequence transmitted fourth in the packet detection slot. The order of these signal sequences is informed using, for example, a beacon.

FIG. 15 shows still another example of the format of packet detection pilot symbols which configure a packet detection symbol sequence. A packet detection symbol sequence 122C shown in FIG. 15 is configured by four packet detection pilot symbols 231, 232, 233, and 234. The packet detection pilot symbol 231 is configured by a signal sequence B having an initial phase=π/4. The packet detection pilot symbol 232 is configured by a signal sequence B having an initial phase=3π/4. The packet detection pilot symbol 233 is configured by a signal sequence B having an initial phase of 5π/4. The packet detection pilot symbol 234 is configured by a signal sequence B having an initial phase=7π/4. Also, it is determined in advance that the signal sequence B having the initial phase=π/4 is a sequence transmitted first in a packet detection slot, the signal sequence B having the initial phase=3π/4 is a sequence transmitted second in the packet detection slot, the signal sequence B having the initial phase=5π/4 is a sequence transmitted third in the packet detection slot, and the signal sequence B having the initial phase=7π/4 is a sequence transmitted fourth in the packet detection slot. The order of these signal sequences is informed using, for example, a beacon.

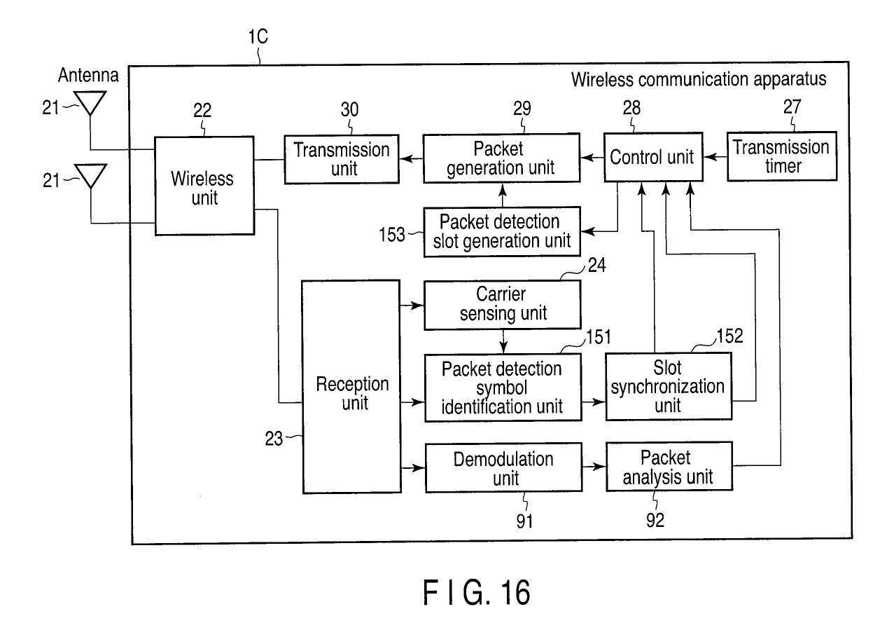

FIG. 16 is a block diagram showing an example of the arrangement of the wireless communication apparatus 1 according to the second embodiment. A wireless communication apparatus 1C shown in FIG. 16 includes antennas 21, a wireless unit 22, a reception unit 23, a carrier sensing unit 24, a packet detection symbol identification unit 151, a slot synchronization unit 152, a demodulation unit 91, a packet analysis unit 92, a transmission timer 27, a control unit 28, a packet detection slot generation unit 153, a packet generation unit 29, and a transmission unit 30. Note that the same reference numerals denote the same parts as in FIGS. 4 and 6, and a detailed description thereof will not be repeated.

The packet detection slot generation unit 153 generates a packet detection slot including a plurality of packet detection pilot symbols which are identifiable from each other, and outputs it to the packet generation unit 29. The packet detection symbol identification unit 151 identifies packet detection pilot symbols included in a packet detection slot, and detects, based on the identification result, what number of a detection pilot symbol in the packet detection slot a symbol of interest is. The slot synchronization unit 152 calculates a slot start time based on the detection result of the packet detection symbol identification unit 151, and executes slot synchronization.

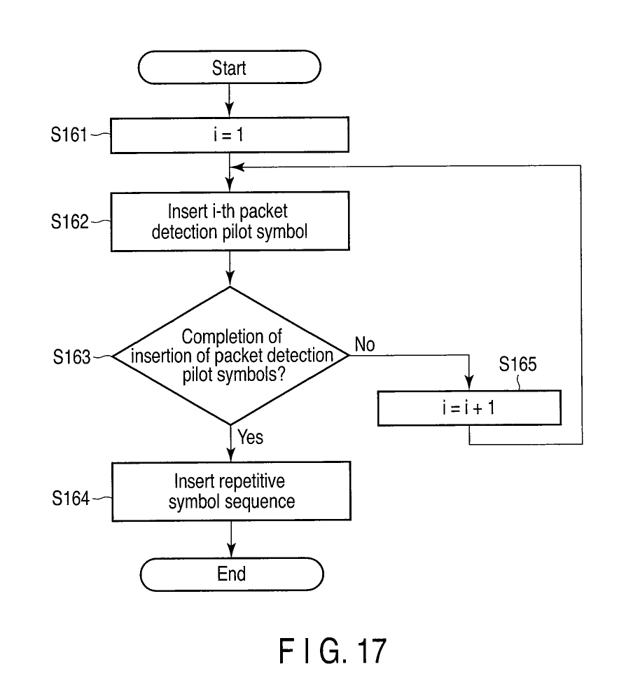

FIG. 17 is a flowchart showing an example of transmission packet generation processing in the wireless communication apparatus 1C. The control unit 28 initializes an index i to i=1 (step S161), and the packet detection slot generation unit 153 inserts the i-th packet detection pilot symbol in a packet detection slot of a transmission packet generated by the packet generation unit 29 (step S162). The control unit 28 determines whether or not packet detection pilot symbols are inserted by the predetermined number (step S163). If the packet detection pilot symbols are not inserted by the predetermined number, the control unit 28 increments i by “1” (step S165), and repeats the processes in step S162 and the subsequent step. If the packet detection pilot symbols are inserted by the predetermined number in step S163, the control unit 28 inserts a repetitive symbol sequence in a subsequent slot (step S164), thus ending the transmission packet generation.

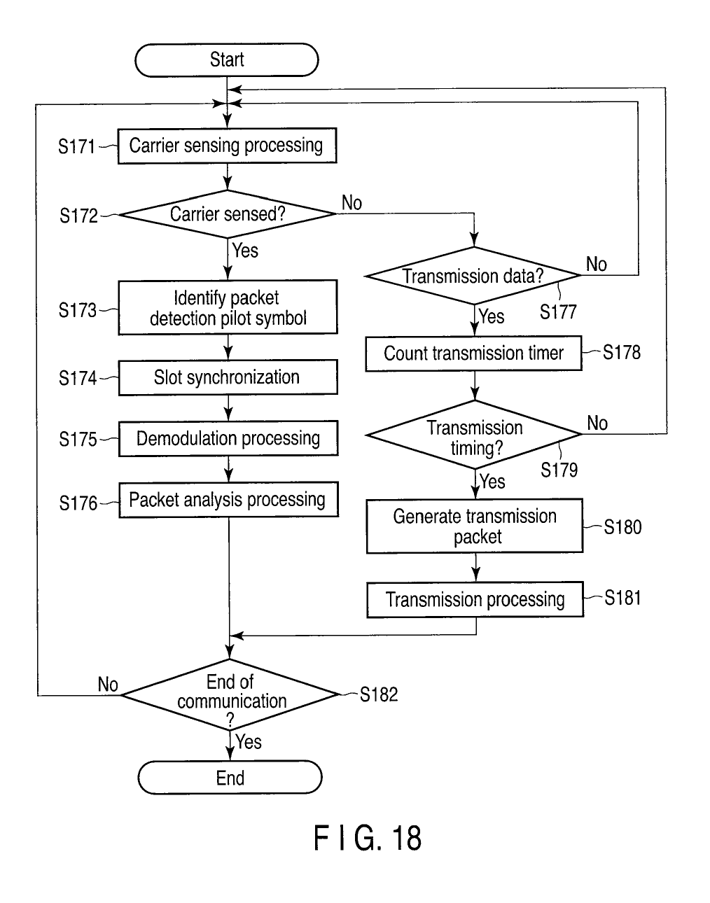

FIG. 18 is a flowchart showing an example of transmission/reception processing in the wireless communication apparatus 10. The carrier sensing unit 24 executes carrier sensing processing for each symbol period (step S171), and determines whether or not a carrier is sensed (step S172). If a carrier is sensed, the packet detection symbol identification unit 151 identifies, based on packet detection pilot symbols included in a packet detection slot in a reception packet, what number of a symbol in the packet detection slot a packet detection pilot symbol of interest is (step S173). The slot synchronization unit 152 executes slot synchronization based on the identification result of the packet detection symbol identification unit 151 (step S174). The slot synchronization is processing for setting a start time of the first packet detection pilot symbol as a slot start time based on the order of packet detection pilot symbols identified by the packet detection symbol identification unit 151. After the slot synchronization, the demodulation unit 91 executes demodulation processing (step S175), and the packet analysis unit 92 executes packet analysis of the demodulated signal (step S176).

On the other hand, if a carrier is not sensed in step S172, it is determined whether or not there is transmission data (step S177). If there is no transmission data, the processes in step S171 and the subsequent steps are repeated. If there is transmission data, the transmission timer 27 counts down a time period (back-off time period) until packet transmission for each slot length (step S178). The control unit 28 determines with reference to the transmission timer 27 whether or not transmission timing is reached (step S179). If the transmission timing is not reached yet, the processes in step S171 and the subsequent steps are repeated. If the transmission timing is reached, the control unit 28 controls the packet generation unit 29 to generate a transmission packet (step S180), and controls to transmit the generated packet via the transmission unit 30, wireless unit 22, and antenna 21 (step S181). After step S176 and step S181, it is determined whether or not a communication is to end in response to, for example, a user request (step S182). If a communication is to end, the processing ends; otherwise, the processes in step S171 and the subsequent steps are repeated.

By inserting packet detection pilot symbols in this way, the slot start time can be detected to take slot synchronization. Even when repetition coding is used, fairness of transmission chances of respective terminals in CSMA/CA accesses can be maintained.

### THIRD EMBODIMENT

In the third embodiment, RTS/CTS exchange is performed using the wireless communication apparatus of the second embodiment. In RTS/CTS exchange, a terminal which wants to transmit data transmits an RTS (Request to Send: transmission request) to a destination, and transmits the data after it receives a CTS (Clear to Send: transmission response) transmitted from the destination in response to this RTS.

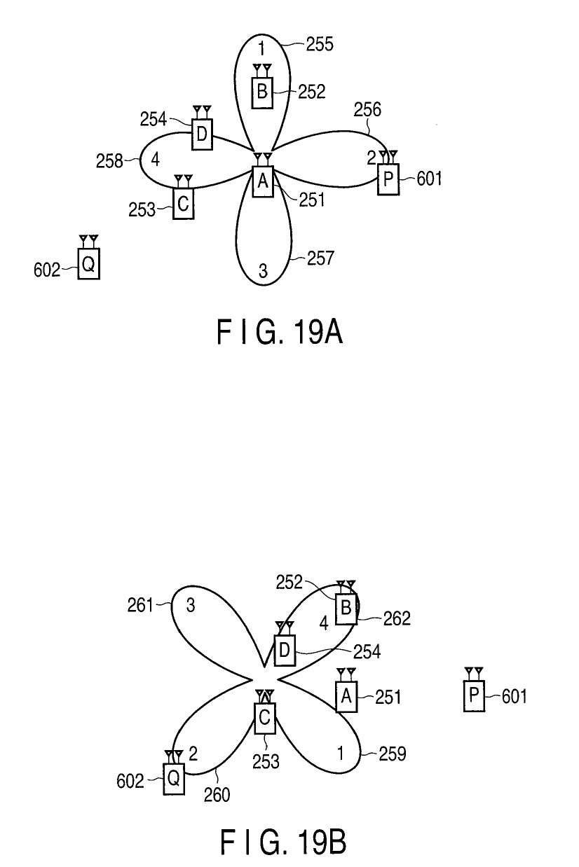

FIGS. 19A and 19B are views showing example of the allocations of wireless communication apparatuses and a repetitive symbol sequence transmitted by the wireless communication apparatus. In FIG. 19A, six wireless communication apparatuses, that is, a wireless communication apparatus A (251), wireless communication apparatus B (252), wireless communication apparatus C (253), and wireless communication apparatus D (254), and also a wireless communication apparatus Q (602) which is located at a position where it cannot detect a signal transmitted by the wireless communication apparatus A (251), and a wireless communication apparatus P (601) which is located at a position where it cannot detect a signal transmitted by the wireless communication apparatus C (253) are allocated. That is, the wireless communication apparatus P is a hidden terminal with respect to the wireless communication apparatus C, and the wireless communication apparatus Q is a hidden terminal with respect to the wireless communication apparatus A. FIG. 19A shows a first symbol 255 of an RTS packet transmitted by the wireless communication apparatus A, a second symbol 256 of the RTS packet transmitted by the wireless communication apparatus A, a third symbol 257 of the RTS packet transmitted by the wireless communication apparatus A, and a fourth symbol 258 of the RTS packet transmitted by the wireless communication apparatus A. In practice, symbols from the first symbol 255 to the fourth symbol 258 are repeated a plurality of times to configure the RTS packet.

FIG. 19B shows a first symbol 259 of a CTS packet transmitted by the wireless communication apparatus C, a second symbol 260 of the CTS packet transmitted by the wireless communication apparatus C, a third symbol 261 of the CTS packet transmitted by the wireless communication apparatus C, and a fourth symbol 262 of the CTS packet transmitted by the wireless communication apparatus C. In practice, symbols from the first symbol 259 to the fourth symbol 262 are repeated a plurality of times to configure the CTS packet.

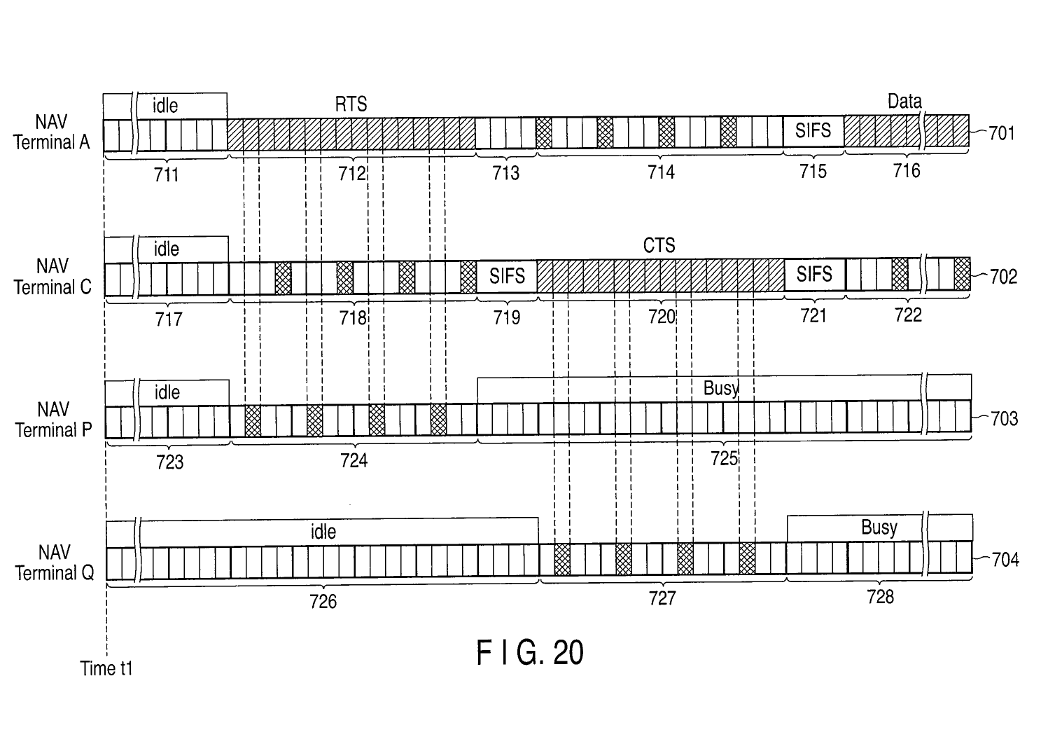

FIG. 20 is a view showing an example of the operation sequences of the six wireless communication apparatuses shown in FIGS. 19A and 19B when a packet detection symbol sequence is inserted, and one repetitive symbol sequence forms one slot. FIG. 20 shows a sequence 701 of the wireless communication apparatus A which transmits an RTS packet and data packet addressed to the wireless communication apparatus C, a sequence 702 of the wireless communication apparatus C which transmits a CTS packet addressed to the wireless communication apparatus A as a response to the RTS packet received from the wireless communication apparatus A, a sequence 703 of the wireless communication apparatus P, and a sequence 704 of the wireless communication apparatus Q. The wireless communication apparatus A transmits an RTS packet addressed to the wireless communication apparatus C (712), and the wireless communication apparatus C receives this packet (718). The wireless communication apparatus P receives the RTS packet since it is located at a position where the apparatus P can receive the RTS packet transmitted by the wireless communication apparatus A, but it determines that a NAV (network allocation vector) value is busy, and does not perform transmission during a period described in the RTS packet since that RTS packet is not addressed to the self terminal (725). The wireless communication apparatus C which received the RTS packet from the wireless communication apparatus A transmits a CTS packet addressed to the wireless communication apparatus A (720), and the wireless communication apparatus A receives this packet (714). The wireless communication apparatus Q receives the CTS packet since it is located at a position where the apparatus Q can receive the CTS packet transmitted by the wireless communication apparatus C, but it determines that a NAV value is busy, and does not perform transmission during a period described in the CTS packet since that CTS packet is not addressed to the self terminal (728). The wireless communication apparatus A which received the CTS packet from the wireless communication apparatus C transmits a data packet (716). Since the wireless communication apparatuses P and Q set a NAV value to be busy, they do not interfere with the data packet transmission of the wireless communication apparatus A, and the data packet reception of the wireless communication apparatus C.

With this arrangement, the same effects as in the second embodiment can be provided, and a hidden terminal problem can be avoided using repetition coding by exchanging RTS/CTS packets.

### FOURTH EMBODIMENT

In the fourth embodiment, the packet detection precision is improved in the wireless communication apparatus of the second embodiment. Note that the fourth embodiment can be similarly applied to the wireless communication apparatus of the first embodiment.

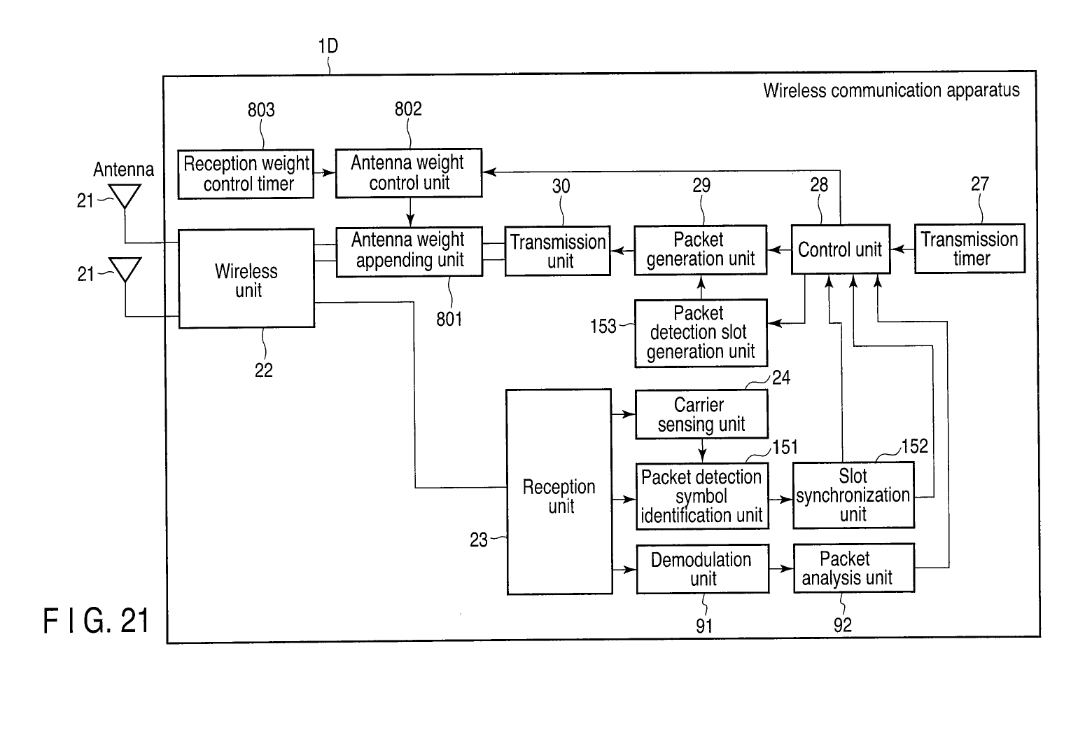

FIG. 21 is a block diagram showing an example of the arrangement of a wireless communication apparatus 1 according to the fourth embodiment. In a wireless communication apparatus 1D, a plurality of antennas 21 are arranged, and an antenna weight appending unit 801, an antenna weight control unit 802, and a reception weight control timer 803 are added in the block diagram shown in FIG. 16.

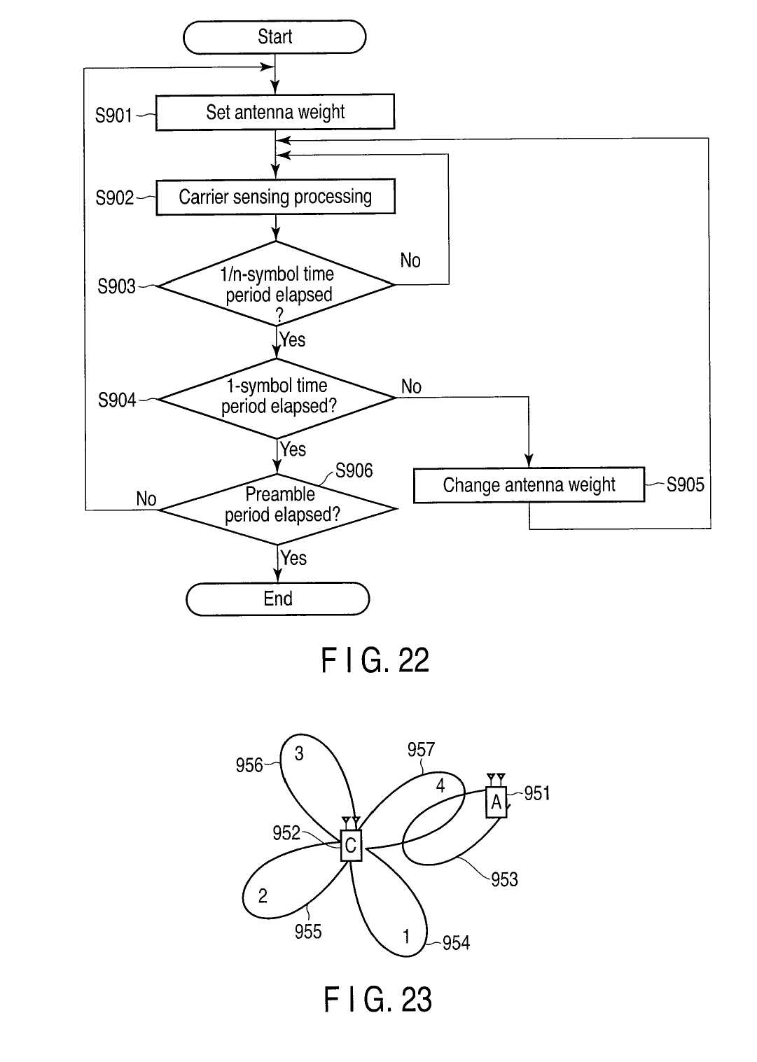

FIG. 22 is a flowchart showing an example of carrier sensing processing executed by the wireless communication apparatus 1D shown in FIG. 21, and shows detailed processing contents of the carrier sensing processing S171 in the flowchart of FIG. 18. The antenna weight control unit 802 sets antenna weights in the antenna weight appending unit 801 (step S901), and a carrier sensing unit 24 executes carrier sensing processing (step S902). The antenna weight control unit 802 determines with reference to the reception weight control timer 803 whether or not a 1/n symbol time period has elapsed (step S903). Note that n is a predetermined integer. If the 1/n symbol time period has not elapsed yet in step S903, the processes in step S902 and the subsequent step are repeated. If the 1/n symbol time period has elapsed, it is determined whether or not a 1-symbol time period has elapsed (step S904). If the 1-symbol time period has not elapsed yet, the antenna weight control unit 802 controls the antenna weight appending unit 801 to change antenna weights (step S905), and repeats the processes in step S902 and the subsequent steps. On the other hand, if the 1-symbol time period has elapsed in step S904, the antenna weight control unit 802 determines whether or not a preamble period has elapsed (step S906). If the preamble period has not elapsed yet, the processes in step S901 and the subsequent steps are repeated; if the preamble period has elapsed, the processing ends.

FIG. 23 is a view showing transmission signals and reception weights of a wireless communication apparatus. During a period in which a wireless communication apparatus A (951) transmits one symbol to have a directionality indicated by 953, a wireless communication apparatus C (952) detects a signal using four different reception weights 954, 955, 956, and 957. In the example shown in FIG. 23, when the wireless communication apparatus C (952) detects a signal from the wireless communication apparatus A (951) using the reception weight 4 (957), the detection probability is highest.

In this way, since packet detection is executed using two or more reception weights during a 1-symbol period, the packet detection precision can be improved.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A wireless communication apparatus comprising:
a reception unit configured to obtain a reception signal by receiving a first packet having, as a unit, a slot including at least two repetitive symbol sequences used to transmit an identical symbol by switching a plurality of antenna beams having different directions;
a carrier sensing unit configured to sense a carrier for each symbol period from the reception signal;
a measurement unit configured to measure a slot length from the reception signal;
a generation unit configured to generate a second packet having the slot as a unit;
a transmission timer unit configured to decrement a time period until transmission of the second packet for each slot length;
a control unit configured to stop, if a carrier is sensed within a time period of the slot length, the transmission timer unit for the time period of the slot length; and
a transmission unit configured to transmit the second packet according to the transmission timer unit.

2. The apparatus according to claim 1, wherein the carrier sensing unit is configured to sense the carrier using a plurality of reception weights within a 1-symbol period.

3. A wireless communication apparatus comprising:
a slot generation unit configured to generate a packet detection slot using a plurality of pilot symbols which are identifiable from each other;
a packet generation unit configured to generate a second packet which has, as a unit, a slot including a plurality of temporally continuous symbols, and includes a packet detection slot generated by the slot generation unit;
a transmission unit configured to transmit the second packet while switching a plurality of antenna beams having different directions for respective symbols;
a reception unit configured to obtain a reception signal by receiving a first packet including a packet detection slot;
a carrier sensing unit configured to sense a carrier for each symbol period from the reception signal; and
a slot synchronization unit configured to calculate, if a carrier is sensed, a start time of the slot based on the pilot symbols included in a packet detection slot in the first packet, and execute slot synchronization.

4. The apparatus according to claim 3, wherein the plurality of pilot symbols have symbol sequences which are different from each other.

5. The apparatus according to claim 3, wherein the plurality of pilot symbols are inserted with an identifier indicating an order of respective pilot symbols in a packet detection slot.

6. The apparatus according to claim 3, wherein the plurality of pilot symbols have phases which are different from each other.

7. The apparatus according to claim 3, wherein the packet generation unit is configured to generate a transmission request packet (RTS: Request to Send) and a transmission response packet (CTS: Clear to Send) as the second packet.

8. The apparatus according to claim 3, wherein the carrier sensing unit is configured to sense the carrier using a plurality of reception weights within a 1-symbol period.

9. A wireless communication apparatus comprising:
a slot generation unit configured to generate a packet detection slot by a plurality of pilot symbols which are identifiable from each other;
a packet generation unit configured to generate a packet which has, as a unit, a slot including a plurality of temporally continuous symbols, and includes a packet detection slot; and
a transmission unit configured to transmit the packet while switching a plurality of antenna beams having different directions for respective symbols.

10. The apparatus according to claim 9, wherein the plurality of pilot symbols have symbol sequences which are different from each other.

11. The apparatus according to claim 9, wherein the plurality of pilot symbols are inserted with an identifier indicating an order of respective pilot symbols in a packet detection slot.

12. The apparatus according to claim 9, wherein the plurality of pilot symbols have phases which are different from each other.

13. The apparatus according to claim 9, wherein the packet generation unit is configured to generate a transmission request packet (RTS: Request to Send) and a transmission response packet (CTS: Clear to Send) as the second packet.

14. A wireless communication apparatus comprising:
a reception unit configured to obtain a reception signal by receiving a packet including a packet detection slot having a plurality of pilot symbols which are identifiable from each other;
a carrier sensing unit configured to sense a carrier for each symbol period from the reception signal; and
a slot synchronization unit configured to calculate, if a carrier is sensed, a start time of the slot based on the pilot symbols included in a packet detection slot in the receiving a packet, and execute slot synchronization.

15. The apparatus according to claim 14, wherein the plurality of pilot symbols have symbol sequences which are different from each other.

16. The apparatus according to claim 14, wherein the plurality of pilot symbols are inserted with an identifier indicating an order of respective pilot symbols in a packet detection slot.

17. The apparatus according to claim 14, wherein the plurality of pilot symbols have phases which are different from each other.

18. The apparatus according to claim 14, wherein the carrier sensing unit is configured to sense the carrier using a plurality of reception weights within a 1-symbol period.
